(19) United States
(12) Patent Application Publication
(10) Pub. No.: US 2023/0367121 A1
(43) Pub. Date: Nov. 16, 2023

(54) IMAGE DISPLAY ELEMENT AND IMAGE DISPLAY DEVICE USING SAME

(71) Applicant: HITACHI-LG DATA STORAGE, INC., Tokyo (JP)

(72) Inventors: Daisuke TOMITA, Tokyo (JP); Hiroyuki MINEMURA, Tokyo (JP); Yumiko ANZAI, Tokyo (JP); Hideo SUENAGA, Tokyo (JP); Yukinobu TADA, Tokyo (JP)

(21) Appl. No.: 17/912,924

(22) PCT Filed: Jun. 17, 2021
(86) PCT No.: PCT/JP2021/023126

§ 371 Date: Sep. 20, 2022

(30) Foreign Application Priority Data
Sep. 9, 2020 (JP) 2020-151505

(51) Int. Cl. G02B 27/01

(52) U.S. Cl. CPC G02B 27/0172

(57) ABSTRACT

An image display element includes an incident diffraction grating which diffracts incident light, and an outgoing diffraction grating from which light that has propagated through the light guide plate after being diffracted by the incident diffraction grating is emitted, the incident diffraction grating and the outgoing diffraction grating being each formed by a pattern of concave-convex formed on a surface of the light guide plate, and the image display element being obtained by joining the light guide plate and a cover glass protecting the pattern of concave-convex or two or more light guide plates with an air layer therebetween by a holding member, and being configured such that the light guide plate and the cover glass are formed by a plastic material, and the holding member has an air vent through which air in the air layer and outside air communicate.

### TECHNICAL FIELD

The present invention relates to an image display element with a light guide plate and an image display device using the same.

### BACKGROUND TECHNOLOGY

In image display devices that enable augmented reality, a user can simultaneously view the surroundings as well as the projected image, and the projected image is superimposed on the real world as perceived by the user. Applications for these image display devices include video games and wearable devices such as eyeglasses. For example, in the case of a head mounted display (HMD: Head Mounted Display), the user wears glasses or goggle-like HMDs that integrate a translucent light guide plate and a projection optical system. The user can view images provided by the projection optical system superimposed on the real world by wearing the HMD, which consists of a translucent light guide plate and projection optical system.

A prior art document in this technical field is Patent Document 1. In Patent Document 1, the light guide plate consists of a plurality of diffraction gratings with concave-convex shapes formed on a glass substrate. Light rays emitted from the projection optical system are coupled to the light guide plate by the incident diffraction grating and propagate inside the light guide plate while undergoing total reflection. The light ray is further converted into multiple light rays that are duplicated by another diffraction grating while propagating inside the light guide plate by total reflection, and finally emitted from the light guide plate. Some of the emitted light rays are projected onto the retina through the user's pupil, and are perceived as an augmented reality image superimposed on the real world image.

### PRIOR ART DOCUMENT

### Patent Document

Patent Document 1: JP 2017-528739 A

### SUMMARY OF THE INVENTION

### Problems to be Solved by the Invention

Patent Document 1 discloses a technology that uses glass material with respect to the substrate material of the light guide plate. Regarding the diffraction grating, it discloses a technique to form the grating by etching the surface of the waveguide (i.e., glass plate). When glass is used for the light guide plate as disclosed in Patent Document 1, there are issues regarding the cost of processing and the weight of the light guide plate when it is installed by the user.

Therefore, using plastic for the light guide plate is a possible solution to this problem. However, compared to conventional glass light guide plates, plastic light guide plates have lower mechanical strength (Young's modulus) and are therefore subject to greater deformation due to environmental temperature and atmospheric pressure.

The purpose of the present invention is to provide an image display element and an image display device using the same, which are constructed in consideration of resistance to environmental changes, while using plastic for the light guide plate.

### Solutions to Problems

The present invention, to give an example, is an image display element having a light guide plate. The image display element comprises an incident diffraction grating which diffracts incident light, and an outgoing diffraction grating from which light that has propagated through the light guide plate after being diffracted by the incident diffraction grating is emitted, the incident diffraction grating and the outgoing diffraction grating being each formed by a pattern of concave-convex formed on a surface of the light guide plate, and the image display element being obtained by joining the light guide plate and a cover glass protecting the pattern of concave-convex or two or more light guide plates with an air layer therebetween by a holding member, and being configured such that the light guide plate and the cover glass are formed by a plastic material, and the holding member has an air vent through which air in the air layer and outside air communicate.

### Effects of the Invention

According to the present invention, while using plastic for the light guide plate, it is possible to provide an image display element and an image display device using the element in a configuration that takes resistance to environmental changes into consideration.

### BRIEF DESCRIPTION OF THE DRAWINGS

FIG. 1 is a schematic diagram of the configuration of an image display element containing a light guide plate using diffraction gratings in Embodiment.

FIG. 2 is an illustration of the diffraction action required in the x direction for the outgoing diffraction grating in Embodiment.

FIG. 3 is a schematic diagram of the configuration of an image display element consisting of two light guide plates and one cover glass in Embodiment.

FIG. 4 is a simulation results of the range of images displayed by the image display element described in FIG. 3.

FIG. 5 is a schematic diagram of the configuration of an image display element composed of two light guide plates in Embodiment.

FIG. 6 is an explanatory diagram showing a state of a light path due to distortion of a light guide plate when the environmental temperature changes in Embodiment.

FIG. 7 is a schematic diagram of the configuration of an image display element with air opening in Embodiment.

FIG. 8 is a schematic diagram of the configuration of an image display element with an air opening formed using adhesive in Embodiment.

FIG. 9 is a schematic diagram of the configuration of an image display element with an air opening as a configuration with a step around a light guide plate and a notch in part of the plate in Embodiment.

FIG. 10 is a schematic diagram of the configuration of an image display element with an air opening protected by a filter in Embodiment.

FIG. 11 is a partial configuration schematic diagram of an image display device containing an image display element configured to have an air opening in the frame in Embodiment.

FIG. 12 is a schematic diagram of the configuration of an image display device containing an image display element in Embodiment.

### MODE FOR CARRYING OUT THE INVENTION

Hereinafter, embodiments of the present invention will be described with reference to the drawings.

### Embodiment

This embodiment describes an image display element in which the material of the light guide plate is plastic material and an image display device using the image display element, and a light guide plate that is less susceptible to environmental changes. In this embodiment, the terms “resin” and “plastic” are used synonymously. Plastic means a material made of a polymer compound, and is a concept that does not include glass but includes resin, polycarbonate, acrylic resin, and light curing resin.

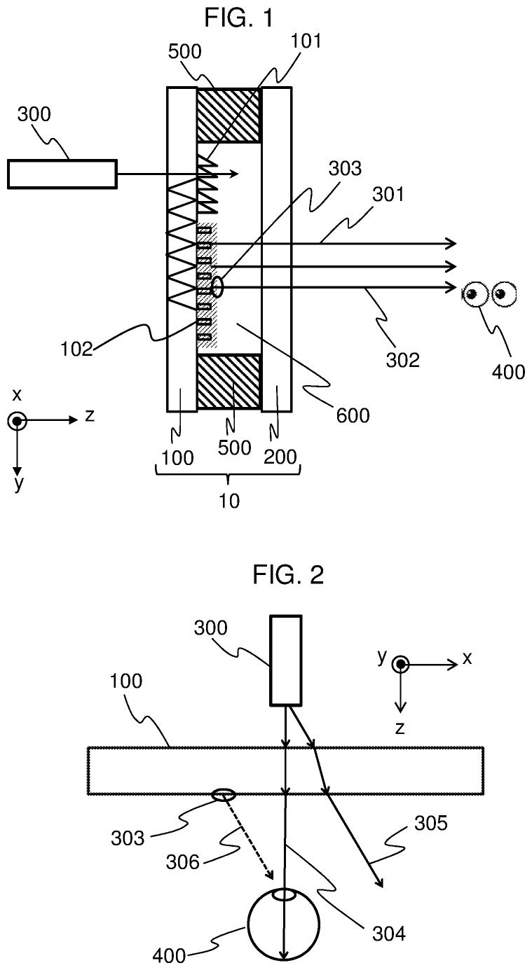

An example of an image display element including a light guide plate is illustrated in FIG. 1. In FIG. 1, the image display element 10 consists of a light guide plate 100, an incident diffraction grating 101, an outgoing diffraction grating 102, a cover glass 200, and a holding member 500.

Incident diffraction grating 101 is a linear surface concave-convex diffraction element. Although blazed grating with high diffraction light efficiency is shown as an example of the incident diffraction grating 101, the type is not limited to any particular type. In FIG. 1, the incident diffraction grating 101 is a reflective diffraction grating formed on the second surface, provided that the surface of the light guide plate 100 on the projection optical system 300 side is the first surface and the opposite side is the second surface. By using a reflective diffraction grating, it is possible to reduce the aspect ratio (height/pitch) by utilizing reflection, which has a greater deflecting effect than refraction, but it is not limited to this. The first surface may be provided with a diffraction grating and may be of a transmission type. Although not shown in the figure, it is desirable to add an optical thin film such as a dielectric multilayer film or other multilayer film with dichroic properties to the incident gratings 101 to improve diffraction efficiency. The film formed on the incident diffraction grating 101 is optimized according to the specifications of each light guide plate, so it is not necessarily limited to a dielectric multilayer film. Metal films such as aluminum films are also acceptable depending on the design specifications.

The light having image information emitted from the projection optical system 300 is incident on the light guide plate 100 and is incident on the reflective incident diffraction grating 101. The incident diffraction grating is a diffraction grating with a wavenumber vector component in the Y direction, and the light diffracted by the incident diffraction grating 101 propagates inside the light guide plate with total reflection. In order to achieve total reflection inside the light guide plate, it is necessary to satisfy the total reflection condition according to Snell's law. In order to totally reflect angular components in a wider range, it is preferable that the difference between the refractive index of the light guide plate 100 and the outside world is larger, and the light guide plate is desirably surrounded by air.

The light propagated in the light guide plate by total reflection is directed to the outgoing diffraction grating 102. Although details of the configuration of the outgoing diffraction grating 102 will be described later, it is a diffraction element having diffraction components in the X and Y directions and having the same pattern period as the incident diffraction grating 101. In this embodiment, the outgoing diffraction grating 102 is described on the same plane as the incident diffraction grating 101, but it is not limited to this and may be arranged on a different plane from the incident diffraction grating 101.

Part of the light diffracted by the outgoing diffraction grating 102 is emitted from the light guide plate 100, transmitted through the cover glass 200 and is emitted in the direction of user's pupil 400. The cover glass 200 is referred to as cover glass in this embodiment, but the material is plastic material.

The emitted light does not necessarily enter the user's pupil 400 depending on the position of the user's pupil 400. In the case of FIG. 1, since the position of the user's pupil 400 is different from the emission position, it is not visually recognized by the user. In the case of FIG. 1, the light path that is not visually recognized by the user is 301. If the user's pupil 400 is approximated as a circle, the output position in the light guide plate that is visible to the user will also be a circle according to the pixel position. Hereafter, this will be referred to as the emission circle 303.

Diffracted light other than the light path of the light path 301 and components not diffracted by the outgoing diffraction grating are totally reflected again in the light guide plate, and by entering the outgoing diffraction grating 102 again, the light passes through the cover glass 200 as light on the light path 302 and is emitted in the direction of the user's pupil 400. By repeating total reflection and diffraction in this manner, the position of the light emitted from the light guide plate 100 is gradually shifted in a parallel direction, and diffracted light from the outgoing diffraction grating 102 positioned within the emission circle 303 forms the light path 302 and enters the user's pupil 400, where it is visually recognized by the user.

Since the angle of the light is the same in the light path 301 and the light path 302, when the light enters the user's pupil 400, the same image information is visually recognized. The light guided into the light guide plate by the incident diffraction grating 101 in this way propagates in the

Y direction and the X direction (not shown) while repeating total reflection and diffraction by the outgoing diffraction grating 102, and is emitted from the light guide plate 100. As a result, since the light path 301 having the same image information can be generated in a wide range, even if the position of the user's pupil 400 changes, the position of the emission circle 303 corresponding to the position of the user's pupil 400 changes and becomes the light path 302 and image information can be visually recognized.

In general, the incident diffraction grating 101 and the exit diffraction grating 102 have a fine concave-convex structure. If oil from human hands, water, or some kind of stress is applied, there is a high possibility that the diffraction function will be hindered, a cover glass 200 is required for protection of these diffraction gratings.

From the viewpoint of preventing dust from entering the air layer 600 between the light guide plate 100 and the cover glass 200, the image display element 10 has a structure in which the peripheries of the light guide plate 100 and the cover glass 200, which do not overlap with the incident diffraction grating 101 and the outgoing diffraction grating 102, are sealed with a holding member 500 such as an adhesive.

In this embodiment, for the sake of simplicity, we have used a configuration of one light guide plate 100 and one cover glass 200. However, this is not limited to this configuration, and a configuration using a plurality of light guide plates is conceivable as a result of changing the configuration of the light guide plate according to the required specifications of the light guide plate. Moreover, there is no problem even if it is applied to both sides of the cover glass in the same manner.

FIG. 2 illustrates that the outgoing diffraction grating 102 must have diffraction action in the x direction. Here, the projection optical system 300, which is the light source for forming the image, and the user's pupil 400 are placed on opposite sides of the light guide plate 100. Assuming that the wavenumber vector of the incident diffraction grating 101 points in the y direction, the arrows in FIG. 2 represent light rays in the x-z plane. Assume here that the incident diffraction grating 101 has no wavenumber vector component in the x direction.

Of the image light rays viewed by the user, the light ray 304 at the center of the displayed image corresponding to the center of the visual field travels straight in the x-z plane and reaches the user's pupil 400 as shown in the figure. Although the diffraction in the y direction, which is the action of the light guide plate 100, is not explicitly expressed, it is possible to diffract the light rays in at least the incident diffraction grating 101 and outgoing diffraction grating 102 at least once each.

On the other hand, of the image light rays viewed by the user, the light ray 305 around the displayed image, corresponding to the periphery of the visual field, travel in the right direction in the figure if there is no diffraction in the x direction. On the other hand, in order for the user to recognize these rays as the projected image, the ray of the same angle must reach the user's pupil 400 through the path shown as visible light ray 306 in the figure. The emission circle 303 is a virtual circle on the outgoing diffraction grating 102 and translated by the user's pupil 400 in the direction of the visible rays. Only the light ray 306 emitted from the emission circle 303 on the outgoing diffraction grating 102 are recognized by the user as the projected image, and the other rays are not recognized. Thus, the outgoing diffraction grating 102 must have diffraction action in the x direction.

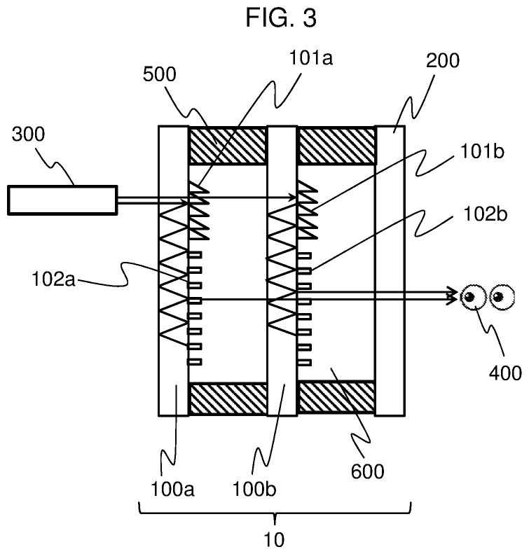

FIG. 3 is a schematic diagram of the configuration of an image display element having two light guide plates. Here, the image display element 10 consists of two light guide plates 100a and 100b and cover glass 200, and light guide plates 100a and 100b are formed with incident diffraction gratings 101a and 101b and outgoing diffraction gratings 102a and 102b, respectively.

The incident diffraction gratings 101a and 101b are linear diffraction gratings with concave-convex surfaces, similar to the incident diffraction grating 101 in FIG. 1, but the type is not particularly limited as with the incident diffraction grating 101 in FIG. 1.

The outgoing diffraction gratings 102a and 102b have the same pattern period as the incident diffraction gratings 101a and 101b, respectively. Coating layers (not shown) may be formed on the surfaces of the outgoing diffraction gratings 102a and 102b, respectively.

The light guide plates 100a and 100b have different pattern periods P1 and P2, respectively, and the corresponding wavelength ranges are different. When P1<P2, light guide plate 100a mainly functions to display the short wavelength side of the color image wavelength range, while light guide plate 100b mainly functions to display the long wavelength side. P1 is 360 nm, for example, and P2 is 460 nm, for example. The number of light guide plates is arbitrary and can be one or more than three, depending on the wavelength of the light to be handled. The pattern period of each light guide plate should be changed according to the wavelength to be handled.

For the aforementioned reasons, the incident diffraction gratings 101a, 101b are arranged on the surfaces of the light guide plates 100a and 100b opposite to the incident surfaces of the image light. In this embodiment, the outgoing diffraction gratings 102a, 102b are formed on the same surface as the incident diffraction gratings 101a, 101b, but it is also possible to form the incident diffraction gratings 101a, 101 and the outgoing diffraction gratings 102a, 102b on opposite sides.

The outgoing diffraction gratings 102a and 102b may have a linear stripe shape similar to the incident diffraction gratings 101a and 101b, or may have a mesh shape. In this embodiment, the outgoing diffraction gratings 102a, 102b are basically formed on only one surface of the light guide plates 100a, 100b. In other words, in the example in FIG. 3, the surfaces of the light guide plates 100a, 100b opposite the outgoing diffraction gratings 102a, 102 are essentially flat without patterns. The surfaces opposite to the outgoing diffraction gratings 102a and 102 are substantially not diffracted, and ideally, the light rays are totally reflected. If one outgoing diffraction grating is dispersedly arranged on both surfaces of the light guide plates 100a and 100b, there is a possibility that both diffraction gratings will be misaligned due to thermal expansion of the light guide plates.

With this configuration, light rays containing image information emitted from the projection optical system 300 can be viewed by the user's pupil 400. Light from the projection optical system 300 enters the image display element 10 from the side opposite to the user's pupil 400. However, the projection optical system 300 does not have to be physically located on the opposite side of the user's pupil 400. Light rays from the projection optical system 300 arranged at an arbitrary position may be made incident from an arbitrary surface of the light guide plates 100a and 100b by a mirror or the like.

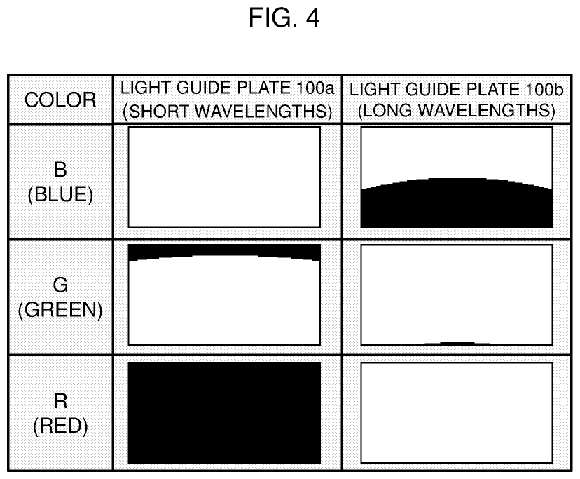

FIG. 4 is a simulation result of the display image range for each light guide plate of the light guide plate described in FIG. 3 and shows a screen image. Here, as shown in FIG. 3, the case of light guide plate composed of two light guide plates 100a (for short wavelengths) and 100b (for long wavelengths) is shown. The pitch of the incoming and outgoing diffraction gratings is 360 nm for light guide plate 100a (for short wavelengths), 450 nm for light guide plate 100b (for long wavelengths), the diagonal viewing angle of the displayed image is 35 degrees, and the aspect ratio is 16:9. As shown in FIG. 4, it can be seen that the display range of the image (indicated by the white area in the figure) for each light guide plate is different.

In this configuration, if the colors of the displayed image are generally R (red), G (green), and B (blue), light guide plate 100a contributes to the display of the B image (blue display image) and part of the G image (green display image), and light guide plate 100b contributes to the display of a portion of the G image (green display image) and the R image (red display image). The incident diffraction grating 101a on the light guide plate 100a in FIG. 3 should reflect and diffract B wavelengths (blue wavelengths) with high diffraction efficiency, reflect and diffract G wavelengths (green wavelengths) with lower diffraction efficiency, and transmit R wavelengths (red wavelengths) almost completely. This means that the diffraction efficiency is strongly dependent on the wavelength. This means that a strong wavelength dependence of diffraction efficiency is required.

In general, dichroic films are known as optical elements that reflect such short-wavelength light rays and transmit long-wavelength light rays, and can be realized with a dielectric multilayer thin film formed on a transparent substrate.

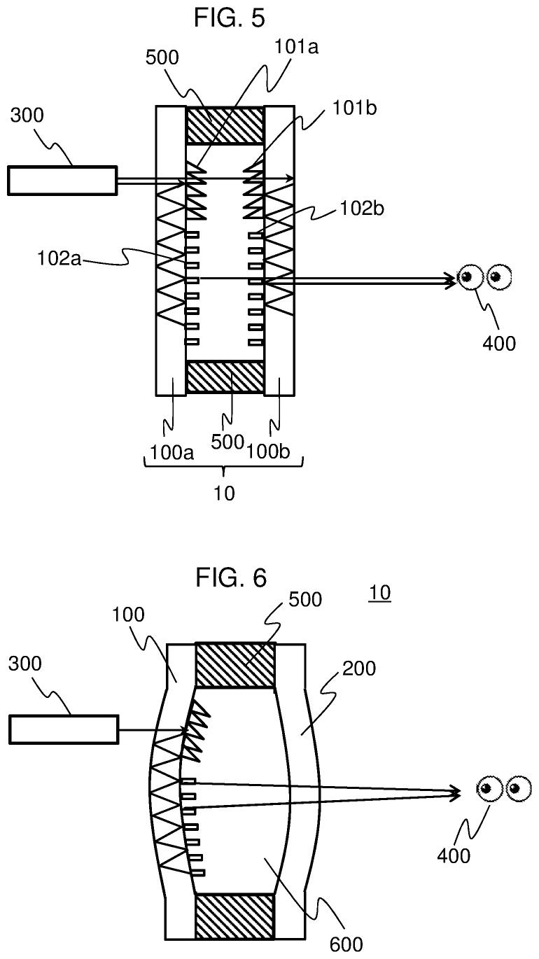

FIG. 5 is a schematic diagram showing the configuration of an image display element when the incident diffraction grating 101b and the outgoing diffraction grating 102b of the light guide plate 100b are arranged on the projection optical system 300 side, as compared with the light guide plate described in FIG. 3. By arranging the incident diffraction grating 101b and the outgoing diffraction grating 102b of the light guide plate 100b on the projection optical system 300 side, the patterns of concave-convex of the incident diffraction grating 101b and the outgoing diffraction grating 102b are arranged in the image display element 10. As a result, direct interference from the outside is avoided, and the configuration eliminates the cover glass for protecting the concave-convex patterns. As explained in FIG. 1, it is preferable to use a reflective diffraction grating for the incident diffraction grating 101, but even in this configuration, it is possible to function as a light guide plate as in FIG. 3.

Here, the resolution of the human eye will be explained. The resolution of the human eye is generally defined as visual acuity, and a visual acuity of 1.0 allows for a viewing angle of 1/60 degree. Therefore, the light emitted from the light guide plate 100 must be emitted with an error of 1/60 degree or less as a standard for retaining image information. Since total reflection propagates repeatedly within the light guide plate, the relative angle of the surfaces must be 1/120 degree or less if the amount of inclination of the surface required for the light guide plate is 1/60 degree for emission. Therefore, plastic light guide plates, which have a lower mechanical strength (Young's modulus) than conventional glass plates, have a problem of surface distortion due to temperature changes caused by changes in the environment.

The issues that arise when plastic material is used for the light guide plate 100 are then explained in detail. A light guide plate made of plastic, which has a lower mechanical strength (Young's modulus) than a conventional one made of glass, is likely to be distorted when the environmental temperature changes. In addition, since the air in the air layer 600 between the light guide plate 100 and the cover glass 200 expands and contracts due to changes in the environmental temperature, if a conventional sealing configuration is adopted, the pressure difference between the air layer and the outside air occurs. Therefore, there is a problem that the light guide plate 100 is distorted.

FIG. 6 is an explanatory diagram illustrating an optical path visually recognized by the user's pupil 400 when the light guide plate 100 and the cover glass 200 are distorted due to air expansion of the air layer 600 between the light guide plate 100 and the cover glass 200, in the image display element with the configuration shown in FIG. 1. As shown in FIG. 6, due to the distortion of the light guide plate 100, light with different optical path angles is mixed, degrading visually recognized image information. Therefore, light guide plates made of plastic materials that can be used in any environment must be able to withstand expansion and contraction due to environmental changes.

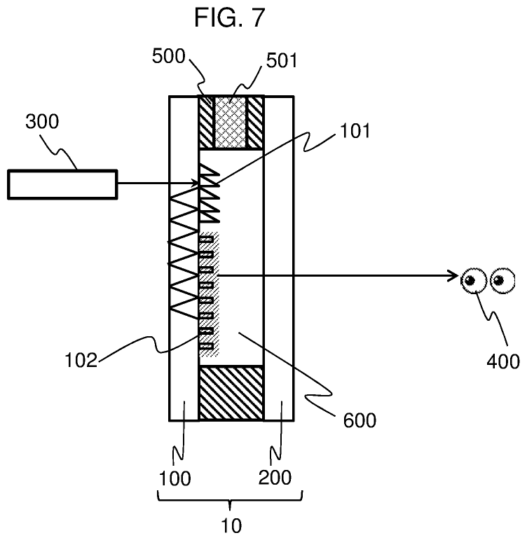

FIG. 7 is a schematic diagram showing the configuration of an image display element in this embodiment, in which the light guide plate is made of a plastic material and is configured to withstand changes in environmental temperature. In FIG. 7, in contrast to the configuration of the image display element 10 described in FIG. 1, an air vent 501 is provided in a part of the holding member 500 for the light guide plate 100 and the cover glass 200 so that the air in the air layer 600 communicates with the outside air so that the air can come and go. By connecting the air layer 600 and the outside air, the air vent 501 can reduce the pressure difference between the air layer 600 and the outside air due to changes in the environmental temperature, thereby suppressing distortion of the light guide plate 100 due to temperature changes. Also, regarding the air vent 501, it is desirable to have one air vent 501 because it is necessary to minimize the intrusion of dust and moisture. By doing so, the coming and going of air can be limited only to the air pressure difference. Regarding the formation position of the air vent 501, it is more effective to position it inside the cover of the image display device than to protrude outside the image display device, which is easily touched by people, in order to prevent water and dust from entering from the outside world, and is preferably formed at the edge around the incident diffraction grating 101. By configuring the air vent 501 in this way, it is possible to configure a plastic light guide plate that can reduce distortion in relation to environmental temperatures.

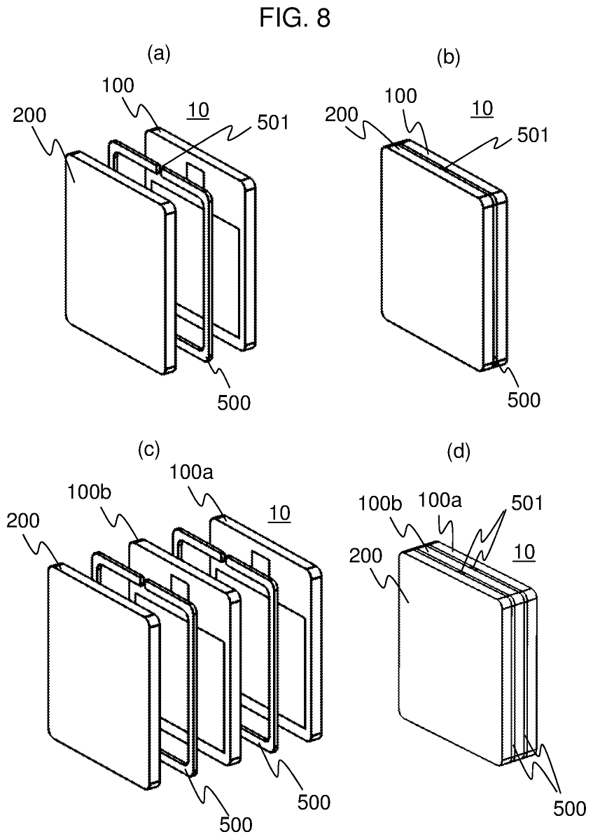

Next, FIG. 8 is a schematic diagram of the configuration of the image display element with the additional air vent described in FIG. 7. In FIG. 8, (a) is an exploded view and (b) is a view after joining (a). As shown in (a) and (b), a holding member 500 is provided between the light guide plate 100 and the cover glass 200, and periphery of the light guide plate 100 and the cover glass 200 are fixed by the holding member 500. At this time, the holding member 500 is made of a film of adhesive, and the air vent 501 is formed by spatially opening a part of this adhesive. Thereby, the pressure difference between the outside air and the air layer can be reduced.

Figures (c) and (d) in FIG. 8 are configuration diagrams of an image display element having a configuration of two light guide plates described in FIG. 3. and (c) is an exploded view and (d) is a view after joining (c). As shown in (c) and (d), similarly to (a) and (b), a part of the holding member 500 is spatially opened to form the air vent 501, and one air vent 501 is provided for one joint. By providing the air vent, the pressure difference between the outside air and the air layer can be reduced.

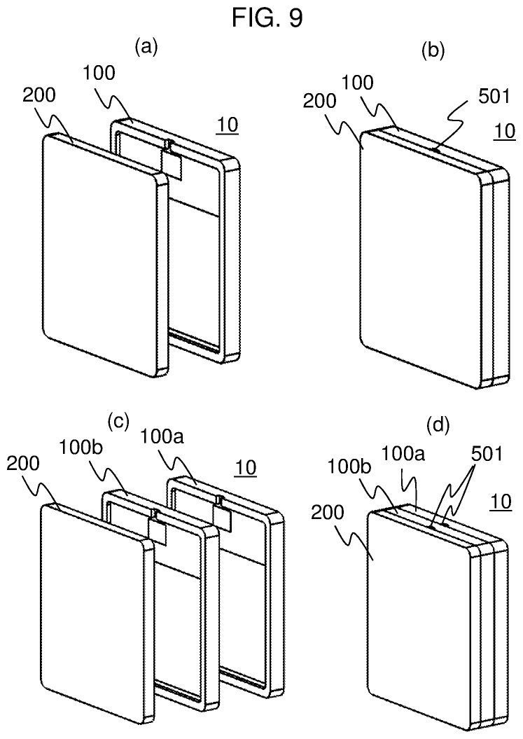

Furthermore, FIG. 9 shows a schematic diagram of the configuration of an image display element in which the shape of the light guide plate is changed to form an air vent. In FIG. 9, (a) is an exploded view and (b) is a view after joining (a). As shown in (a), a step is provided around the light guide plate 100, and when the light guide plate 100 is bonded together as shown in (b), the configuration is such that an air vent is provided for the height of the step added to the light guide plate 100. In this manner, the light guide plate and the holding member are integrally molded from plastic and form a notch-shaped part where there is no step in a part of the stepped part. As a result, the air vent 501 can be formed at the time of pasting, and even with this configuration, the pressure difference between the outside air and the air layer can be reduced.

Figures (c) and (d) in FIG. 9 are configuration diagrams of an image display element having a configuration of two light guide plates described in FIG. 3. and (c) is an exploded view and (d) is a view after joining (c). As shown in (c) and (d), similarly to (a) and (b), a step is provided around the light guide plate 100, a part of the stepped portion is formed with a notch-like portion without a step, and one joint is provided with one air vent. Thereby, the pressure difference between the outside air and the air layer can be reduced.

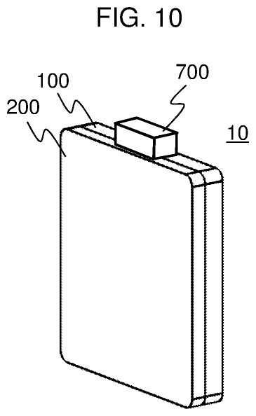

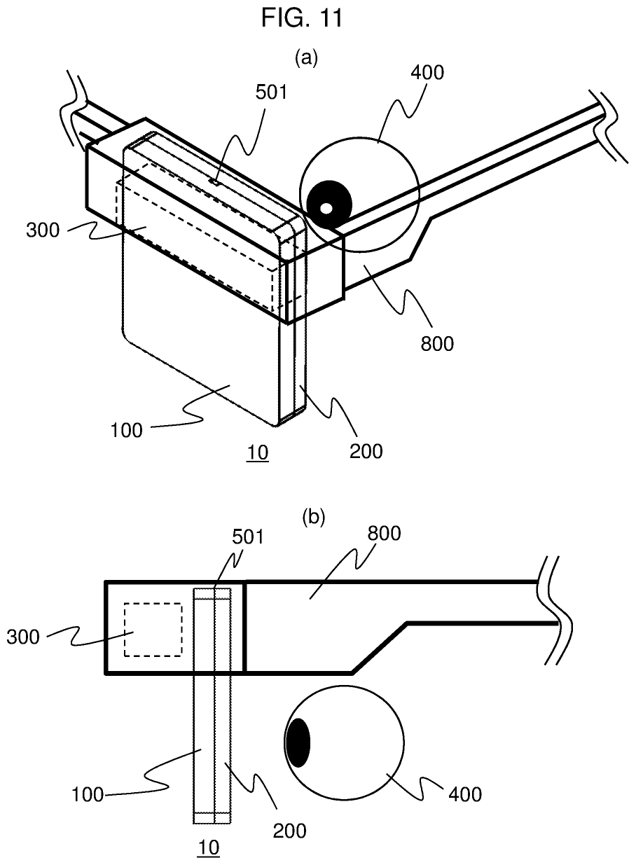

FIG. 10 is a schematic diagram showing the configuration of an image display element in which a filter 700 is added to prevent extremely fine dust and moisture from entering the air vent 501 shown in FIGS. 8 and 9. By adding the filter 700, it is possible to prevent the intrusion of dust due to the coming and going of the air caused by the pressure difference with the outside air.

FIG. 11 is a schematic diagram of a partial configuration of an image display device including an image display element for explaining the installation positions of the air vent. In FIG. 11, (a) is a diagonal view of the image display device and (b) is a side view of the image display device. As shown in FIG. 11, the image display element 10 is held by a frame 800 together with the projection optical system 300 and used in an image display device. Since the air vent 501 needs to be in a state where fine dust and moisture do not enter, it is desirable that it be inside the frame 800.

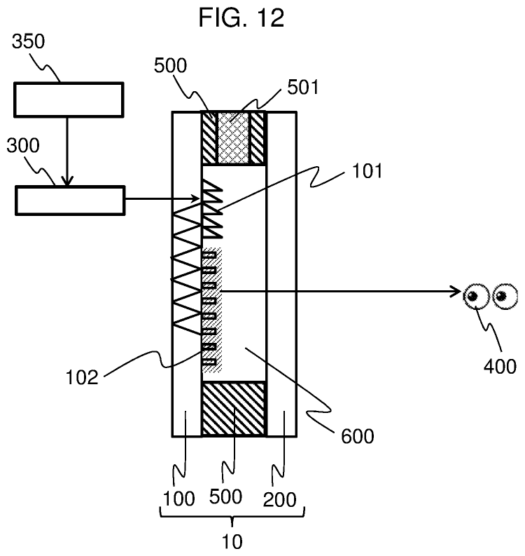

FIG. 12 is a schematic diagram of the image display device in this embodiment. In FIG. 12, the image display device consists of an image display element 10, a projection optical system 300, and a display image control unit 350 that controls the projection optical system 300. The image display element 10 is compact by combining a light guide plate and diffraction elements, and plastic is used as the material of the light guide plate 100 to reduce weight. The reflective incident diffraction grating 101 reflects light inside the light guide plate 100, so that the light guide plate 100 is placed on the opposite side (second side) of the plane of incidence (first side) of the image light rays into the light guide plate 100.

When multiple light guide plates 100 are used, as an example of the configuration of the incident diffraction grating 101, a multilayer dielectric film is effective due to its excellent wavelength selectivity. As an example of the configuration of the outgoing diffraction grating 102, a grating-type diffraction grating can be used to obtain high diffraction efficiency with a low aspect ratio.

The configuration of the image display element 10 is not limited to the above, and various configurations of the incident and outgoing diffraction gratings are possible. Even in such cases, the diffraction efficiency can be improved and luminance can be increased by controlling the characteristics of the film to be formed according to the reflection diffraction efficiency and transmission diffraction efficiency required for the incident and outgoing diffraction gratings, respectively.

In FIG. 12, light having image information emitted from the projection optical system 300 is delivered to the user's pupil 400 by the action of the light guide plate 100, thereby realizing augmented reality. In the light guide plate 100, the pitch and depth of the diffraction gratings formed are optimized for each color.

Further, image information is also provided by an information processing device such as a smartphone or a personal computer, which is not shown in the figure. The image display device may be an HMD, for example.

The image forming method of the projection optical system 300 includes, for example, an image forming apparatus comprising a reflective or transmissive spatial light modulator, a light source and a lens, an image forming apparatus comprising an organic and inorganic EL (Electro Luminescence) element arrays and lenses, an image forming apparatus comprising a light emitting diode array and a lens, and image forming apparatus combining a light source, a semiconductor MEMS mirror array and a lens, etc., widely known projectors can be used. Also, it is possible to use an LED or a laser light source and the tip of an optical fiber that is resonated by MEMS technology, PZT, or the like.

Among these, the most common is an image forming apparatus composed of a reflective or transmissive spatial light modulator, a light source, and a lens. Here, examples of the spatial light modulator include transmissive or reflective liquid crystal display devices such as LCOS (Liquid Crystal On Silicon) and digital micromirror devices (DMD). As a light source, a white light source separated into RGB may be used, or an LED or laser corresponding to each color may be used.

Furthermore, the reflective spatial light modulator can comprise a liquid crystal display device and a polarizing beam splitter that reflects a portion of the light from the light source and directs it to the liquid crystal display device and passes a portion of the light reflected by the liquid crystal display device to a lens-based collimating optical system. The light emitting elements comprising the light source can be red light emitting elements, green light emitting elements, blue light emitting elements, and white light emitting elements. The number of pixels may be determined based on the specifications required for the image display device. Specific values of the number of pixels include 320×240, 432×240, 640×480, 1024×768, and 1920×1080 in addition to 1280×720 shown above.

In the image display device of the present embodiment, the projection optical system 300 is positioned so that the light rays containing image information emitted from the projection optical system 300 are applied to the incident diffraction gratings of the light guide plate 100, and the projection optical system 300 and the image display element 10 are integrally formed.

In the embodiment described above, in the image display element having the surface concavo-convex diffraction grating, for example, a mesh-type diffraction grating is used as the outgoing diffraction grating, which is integrally molded with a material having the same refractive index as that of the waveguide by injection molding or the like. As a result, the light guide plate can be made of plastic, and the light guide plate can be manufactured at low cost and light weight.

Although the present embodiment shows a case in which image information is provided to the user as an image display device, the image display device may also be equipped with various other sensors such as touch sensors, temperature sensors, and acceleration sensors to acquire information about the user and the outside world, and an eye tracking mechanism for measuring the movement of the user's eyes.

As described above, according to the present embodiment, in an image display element combining a light guide plate and a diffraction element, while using plastic for the light guide plate, it is possible to reduce changes in air pressure in the air layer between the light guide plates due to environmental changes and to guide good image information to the user's eyes, and to achieve lower processing costs and weight reduction.

Although the embodiments have been described above, the present invention is not limited to the embodiments described above and includes various modification examples. For example, the embodiments described above have been described in detail in order to explain the present invention in an easy-to-understand manner, and are not necessarily limited to those having all the configurations described.

### REFERENCE SIGNS LIST

10 Image display element
100, 100a, 100b Light guide plate
101, 101a, 101b Incident diffraction grating
102, 102a, 102b Outgoing diffraction grating
200 Cover glass
300 Projection optical system
301 Non-visible light path
302 Visible light path
303 Emission circle
304, 305, 306 Light ray
350 Display image control unit
400 User's pupil
500 Holding member
501 Air vent
600 Air layer
700 Filter
800 Frame

1. An image display element having a light guide plate, comprising:
an incident diffraction grating that diffracts incident light; and
an outgoing diffraction grating from which light diffracted by the incident diffraction grating propagates in the light guide plate and the propagated light exits,
wherein the incident diffraction grating and the outgoing diffraction grating are formed by a pattern of concave-convex formed on the surface of the light guide plate,
a cover glass that protects the light guide plate and the pattern of concave-convex, or two or more of the light guide plates are joined by a holding member via an air layer,
the light guide plate and the cover glass are made of plastic material, and
the holding member has an air vent through which an air in the air layer communicates with an outside air.

2. The image display element according to claim 1,
wherein the holding member is formed of an adhesive.

3. The image display element according to claim 1,
wherein the light guide plate and the holding member are integrally molded of plastic.

4. The image display element according to claim 1,
wherein a filter is provided in the air vent of the holding member.

5. The image display element according to claim 1,
wherein the air vent of the holding member has one air vent for one joint.

6. The image display element according to claim 1,
wherein the image display element is held in a frame and used in an image display device, and
the air vent of the holding member is provided inside the frame.

7. An image display device comprising: the image display element according to claim 1; and
a projection optical system for irradiating the image display element with a light containing image information,
wherein the light containing image information is incident on the incident diffraction grating.
